(19) United States
(12) Patent Application Publication
(10) Pub. No.: US 2015/0212946 A1
(43) Pub. Date: Jul. 30, 2015

(54) INFORMATION PROCESSOR AND INFORMATION PROCESSING METHOD THAT ENSURES EFFECTIVE CACHING

(71) Applicant: KYOCERA Document Solutions Inc., Osaka (JP)

(72) Inventor: Satoshi GOSHIMA, Osaka (JP)

(73) Assignee: KYOCERA DOCUMENT SOLUTIONS INC., Osaka (JP)

(21) Appl. No.: 14/602,879

(22) Filed: Jan. 22, 2015

(30) Foreign Application Priority Data
Jan. 27, 2014 (JP) 2014-012020

(51) Int. Cl. G06F 12/08

(52) U.S. Cl. CPC G06F 12/0868; G06F 12/0875; G06F 2212/452; G06F 2212/283

(57) ABSTRACT

An information processor includes a CPU, a primary storage unit, a secondary storage unit, a cache memory, and a cache controller. The primary storage unit stores the at least one program and data. The data is used by at least one process generated by execution of the at least one program in the CPU. The secondary storage unit stores the at least one programs and the data. The secondary storage unit has a lower access speed than an access speed of the primary storage unit. The cache memory caches the data. The at least one process exchanges the data between the primary storage unit and the secondary storage unit. The cache controller controls the caching of the data based on caching necessity information, the caching necessity information being determined for each of the processes and indicating whether the caching of the data is necessary or not.

### INCORPORATION BY REFERENCE

This application is based upon, and claims the benefit of priority from, corresponding Japanese Patent Application No. 2014-012020 filed in the Japan Patent Office on Jan. 27, 2014, the entire contents of which are incorporated herein by reference.

### BACKGROUND

Unless otherwise indicated herein, the description in this section is not prior art to the claims in this application and is not admitted to be prior art by inclusion in this section.

A typical information processor has used a cache system to improve the performance in exchanging data with an auxiliary storage device in which process speed is relatively slow.

For example, assume that there is a sequence of request for reading from a magnetic disk device occurs. In this case, in a known technique, data read out from the magnetic disk device is sent to a process such as an Operating System (OS) and an application program that has requested the data, and the data is also stored into a semiconductor disk device used as a disk cache.

Next, when the sequence of request for reading from the magnetic disk device occurs, the data is read from the semiconductor disk device when the identical data is stored in the semiconductor disk device. Then, this consequently ensures the high speed read out of the data.

The semiconductor disk device is constituted of flash memories. Then, the saved cached data remains effective without loss through turning off and reboot of the system. Thus, even when the system is turned off, the content of disk cache, which is established until then and with high hit ratio, can be remained effective.

Typically, OS caches the data that is read from the file system created on the auxiliary storage device as long as the memory used for cache has a margin. Then, when the cache memory becomes to have a low margin, new data is read into the cache after the cached data where access time is the oldest is erased by Least Recently Used (LRU) algorithm, for example.

### SUMMARY

An information processor according to one aspect of the disclosure includes a CPU, a primary storage unit, a secondary storage unit, a cache memory, and a cache controller. The CPU executes at least one program. The primary storage unit stores the at least one program and data. The data is used by at least one process generated by execution of the at least one program in the CPU. The secondary storage unit stores the at least one programs and the data. The secondary storage unit has a lower access speed than an access speed of the primary storage unit. The cache memory caches the data. The at least one process exchanges the data between the primary storage unit and the secondary storage unit. The cache controller controls the caching of the data based on caching necessity information, the caching necessity information being determined for each of the processes and indicating whether the caching of the data is necessary or not.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram illustrating a block configuration of an embedded device according to an embodiment of the present disclosure;

FIG. 2 illustrates a tabular diagram of a cache management table according to the embodiment; and

FIG. 3 illustrates a flowchart of caching process of data in the embedded device according to the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

### Outline

The embedded device according to the embodiment executes a method for determining which data should be cached and which data is not required to be cached among data read into the cache memory from the auxiliary storage unit.

Whether or not the data should be cached is determined by providing information indicative of necessity of caching (hereinafter referred to as “caching necessity information”) to each process of reading data from the auxiliary storage unit. That is, in the embedded device of the embodiment, a process ID that is allocated to each process is associated with the caching necessity information and held as a cache management table. Based on this caching necessity information, the caching system caches the data that is read into the cache memory from the auxiliary storage unit or deletes the data immediately.

Thus, the embedded device according to the embodiment immediately deletes the data that is not necessary to cache among data read into the cache memory from the auxiliary storage unit. This avoids the cache memory from being fully occupied.

Then, since the cache memory is unlikely to be fully occupied, this can reduce the occasion to perform the cache out process that costs time. This results in the reduced negative effect on the performance of the whole embedded device.

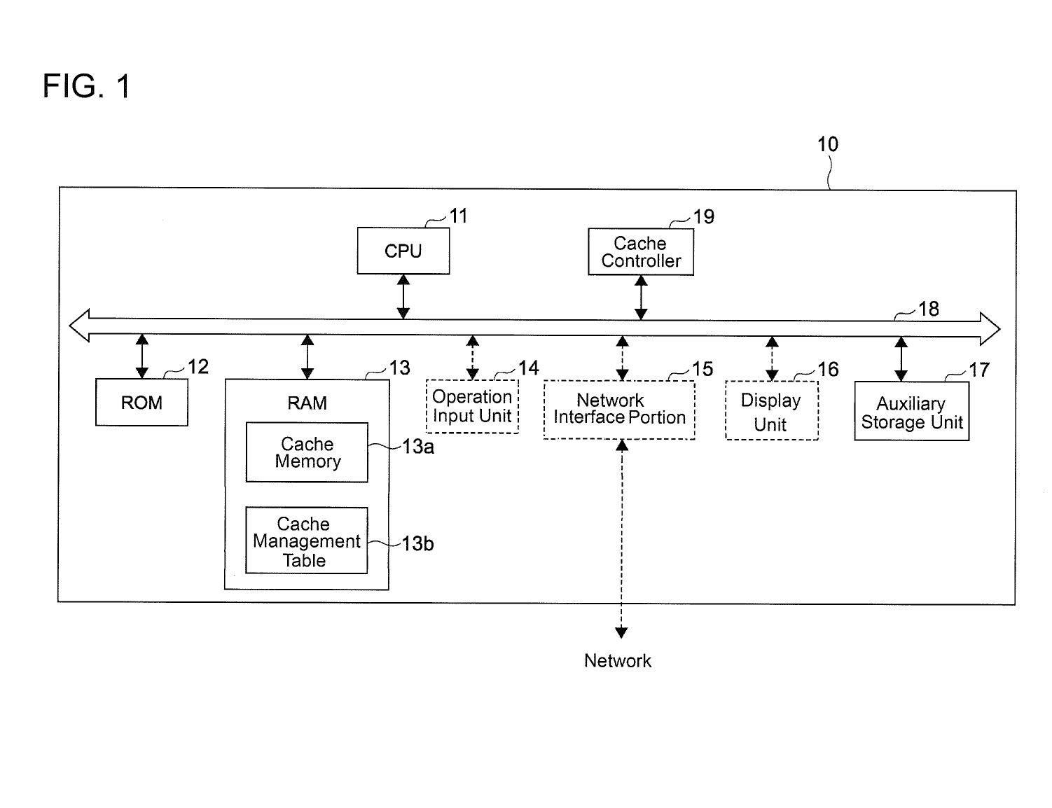

Next, the configuration of the embedded device according to this embodiment will be described. FIG. 1 is a schematic diagram of a block configuration of an embedded device 10 according to the embodiment. The embedded device 10 is assumed to be embedded in mainly image forming apparatuses such as Multifunction Peripheral (MFP).

As illustrated in FIG. 1, the embedded device (information processor) 10 includes a Central Processing Unit (CPU) 11, a Read Only Memory (ROM) 12, a Random Access Memory (RAM, primary storage unit) 13, an auxiliary storage unit (secondary storage unit) 17, and a cache controller 19. Each of the blocks is connected via a bus 18.

The embedded device 10 may include such as an operation input unit 14, a network interface unit 15, and a display unit 16. However, these are not essential components as the embedded device 10. Then, these are indicated by the dotted line in FIG. 1.

The ROM 12 fixedly stores a plurality of programs and data, such as firmware, to execute various processes.

The RAM 13 is used as a work area of the CPU 11, and the RAM 13 temporarily holds OS, various application programs in execution, and various data in process. The RAM 13 includes a cache memory 13a as a region to cached data that is exchanged between the RAM 13 and the auxiliary storage unit 17. The cache memory 13a may be located in a place other than the RAM 13.

The RAM 13 stores a cache management table 13b that holds the set of the process IDs of the processes to read data from the auxiliary storage unit 17 and information (caching necessity information) on whether or not to cache the data read on the process. The cache management table 13b will be described later.

The auxiliary storage unit 17 is, for example, a Hard Disk Drive (HDD), a flash memory, and other non-volatile memory. The auxiliary storage unit 17 stores OS, various application programs, and various data.

The cache controller 19 determines whether the data is exchanged between the RAM 13 and the auxiliary storage unit 17 is remained caching in the cache memory 13a or caused to be cache out for caching control. The details will be described later. The cache controller 19 may be equipped as an independent hardware unit indicated in FIG. 1, or may be achieved by the execution of the program by the CPU 11.

The network interface unit 15 is connected to a network to exchange information with the outside of the embedded device 10.

The CPU 11 expands a plurality of programs, which are stored in the ROM 12 and the auxiliary storage unit 17, on the RAM 13. The CPU 11 controls respective units as necessary according to the expanded program.

The operation input unit 14 is, for example, a pointing device such as a computer mouse, a keyboard, a touch panel, and other operation device.

The display unit 16 is, for example, a liquid crystal display, an Electro-Luminescence (EL) display, a plasma display, a Cathode Ray Tube (CRT) display, and similar display. The display unit 16 may be included in the embedded device 10 or may be externally connected.

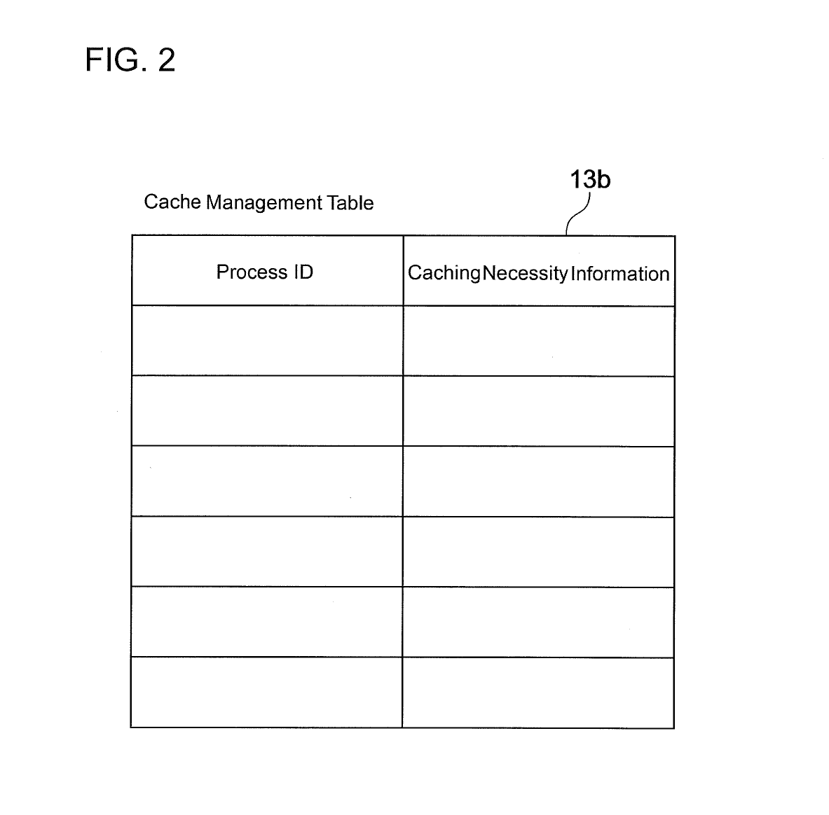

Next, a description will be given of the above-described cache management table 13b. FIG. 2 is a tabular diagram illustrating a cache management table.

As illustrated in FIG. 2, the cache management table 13b is constituted of one or more sets associating the processes ID with the pieces of caching necessity information. The process ID is an ID indicative of the process executed on the CPU 11. The caching necessity information is information indicative of whether the data where the process has read from the auxiliary storage unit 17 is necessary to be held in the cache memory or not. Use of the cache management table ensures the necessity of data caching to be controlled easily for each process.

In the embedded device 10 embedded in the image forming apparatus, for example, the process includes a process of image processing, a process for controlling the respective devices in the image forming apparatus such as a print control unit, a process for controlling the state of the image forming apparatus, and similar process.

The setting of the necessity of caching to the caching necessity information may be specified by a programmer when the program underlying the process is designed, or may be specified by an operator when the embedded device 10 is operated, and further, may be specified automatically by the other process.

While in the above description the cache management table 13b is disposed in the RAM 13, in addition, the cache management table 13b may be stored anywhere the cache controller 19 can refer. What sort of process is necessary or not necessary to cache the data cannot be said sweepingly. The necessity of caching is set on a case-by-case basis when the system is designed or operated for example.

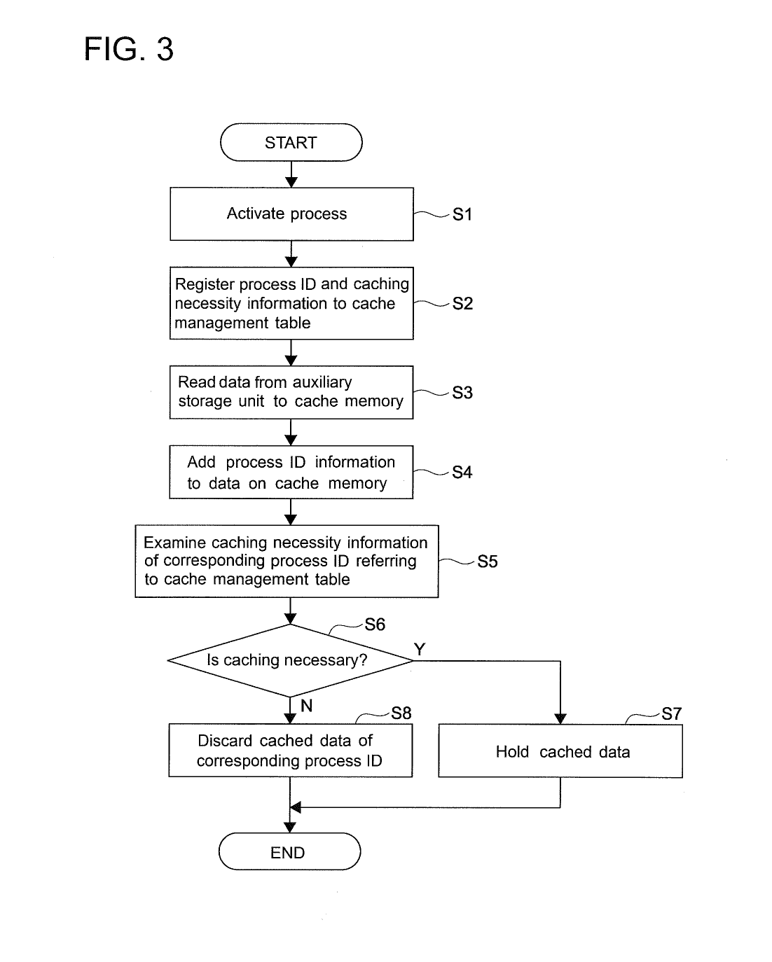

FIG. 3 is a flowchart of the caching process of the data in the embedded device 10 according to the embodiment.

First, the execution of the program in the CPU 11 causes the process to be activated (the step S1). To the activated process, a process Identifier (ID) to identify process uniquely is allocated.

Next, each activated process registers its process ID and caching necessity information to the cache management table 13b (the step S2). The process ID and caching necessity information may be registered by the cache controller 19.

Next, the activated process reads the data from the auxiliary storage unit 17 as necessary (the step S3). The data to read is stored in the cache memory 13a.

Next, the cache controller 19 adds the information on the process ID of the process that has read the data to the data on the cache memory 13a (the step S4). Adding the process ID information to the data on the cache memory 13a at this point ensures the easy management of the data on the cache memory 13a based on the process ID.

Next, the cache controller 19 refers to the cache management table 13b and examines the caching necessity information of the process that has read the data (the step S5).

Next, the cache controller 19 determines whether or not the caching of the read data is necessary based on the caching necessity information (the step S6).

When the caching is not necessary (No in the step S6), the cache controller 19 discards the cached data of the process (the step S8).

When the caching is necessary (Yes in the step S6), the cache controller 19 holds the cached data of the process on the cache memory 13a (the step S7). The data held on the cache memory 13a is a target of the cache out by such as the LRU algorithm when the cache memory 13a becomes fully occupied.

The embedded device according to the embodiment immediately deletes the data that is not necessary to cache among data read into the cache memory from the auxiliary storage unit. This avoids the cache memory from being fully occupied.

Then, since the cache memory is unlikely to be fully occupied, this can reduce the occasion to perform the cache out process that costs time. This results in the reduced negative effect on the performance of the whole embedded device.

### Application to Virtual Storage

In the above description, the information processor according to the embodiment is described as a cache system that exchanges data with the file system. However, recently, the cache of the file system is integratedly controlled with a virtual storage in OS.

This ensures a mechanism that causes each process to hold information of which data should be cached to be applied to a virtual storage that adopts paging method. Then, if such as a page fault occurs in the virtual storage system, the page-in/page-out can be performed efficiently.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An information processor, comprising:
a CPU that executes at least one program;
a primary storage unit that stores the at least one program and data, the data being used by at least one process generated by execution of the at least one program in the CPU;
a secondary storage unit that stores the at least one programs and the data, the secondary storage unit having a lower access speed than an access speed of the primary storage unit;
a cache memory that caches the data, the at least one process exchanging the data between the primary storage unit and the secondary storage unit; and
a cache controller that controls the caching of the data based on caching necessity information, the caching necessity information being determined for each of the processes and indicating whether the caching of the data is necessary or not.

2. The information processor according to claim 1,
wherein the cache controller adds process ID information of the process that has read the data to the read data when the cache controller reads the data stored in the primary storage unit into the cache memory.

3. The information processor according to claim 2,
wherein the cache controller uses a cache management table to control caching, the caching necessity information associated with the process ID information being stored in the cache management table.

4. An information processing method using a CPU, a primary storage unit, and a secondary storage unit, comprising:
executing at least one program at the CPU;
storing the at least one program and data into the primary storage unit, the data being used by at least one process generated by execution of the at least one program in the CPU;
storing the at least one programs and the data into the secondary storage unit, the secondary storage unit having a lower access speed than an access speed of the primary storage unit;
caching the data, the at least one process exchanging the data between the primary storage unit and the secondary storage unit; and
controlling the caching of the data based on caching necessity information, the caching necessity information being determined for each of the processes and indicating whether the caching of the data is necessary or not.

5. A non-transitory computer-readable recording medium storing an information processing program to control an information processor, the information processing program causing a computer to function as:
a CPU that executes at least one program;
a primary storage unit that stores the at least one program and data, the data being used by at least one process generated by execution of the at least one program in the CPU;
a secondary storage unit that stores the at least one programs and the data, the secondary storage unit having a lower access speed than an access speed of the primary storage unit;
a cache memory that caches the data, the at least one process exchanging the data between the primary storage unit and the secondary storage unit; and
a cache controller that controls the caching of the data based on caching necessity information, the caching necessity information being determined for each of the processes and indicating whether the caching of the data is necessary or not.
